(19) United States
(12) Patent Application Publication
(10) Pub. No.: US 2014/0379925 A1
(43) Pub. Date: Dec. 25, 2014

(54) APPARATUS AND METHOD FOR INTERWORKING BETWEEN APP STORE SERVERS TO SHARE APPLICATION INFORMATION

(71) Applicant: Electronics and Telecommunications Research Institute, Daejeon-si (KR)

(72) Inventors: Tae-Gun KANG, Daejeon-si (KR); Seung-Chul KIM, Daejeon-si (KR); Seung-Hee KIM, Daejeon-si (KR); Sang-Taick PARK, Daejeon-si (KR); Sang-Yun LEE, Daejeon-si (KR); In-Cheol JEONG, Daejeon-si (KR); Jin-Woo HONG, Daejeon-si (KR)

(73) Assignee: Electronics and Telecommunications Research Institute, Daejeon-si (KR)

(21) Appl. No.: 14/310,306

(22) Filed: Jun. 20, 2014

(30) Foreign Application Priority Data
Jun. 21, 2013 (KR) 10-2013-0071900
May 27, 2014 (KR) 10-2014-0064019

(51) Int. Cl. H04L 29/08

(52) U.S. Cl. CPC H04L 67/1014
USPC 709/226

(57) ABSTRACT

An apparatus and method for interworking between a plurality of app store servers to share app information therebetween, which enables conventional app store servers to access app information of apps registered with each app store server through one app store server based on an open service interface.

### CROSS-REFERENCE TO RELATED APPLICATIONS

This application claims priority from Korean Patent Application Nos. 10-2013-0071900, filed on Jun. 21, 2013, and 10-2014-0064019, filed on May 27, 2014, in the Korean Intellectual Property Office, the entire disclosures of which are incorporated herein by references for all purposes.

### BACKGROUND

1. Field

The following description relates to an apparatus and method for interworking between a plurality of application store (“app store”) servers to share app information between these servers.

2. Description of Related Art

An app store, which is short for an application store, refers to online content (software) markets where applications (e.g., content applications of schedule management, address book, alarm, calculator, game, video, internet connection, music playback, navigation, MS-Word, Excel, and the like, that are installed on a user terminal) may be freely sold and bought.

Such an app store is an open market where applications (“apps”) are developed and sold by individuals, rather than being developed by large app developers and sold by mobile carriers, and anyone can sell, to users around the world, their own apps developed by using programs such as software development kit (SDK), Xcode, or the like that are made public by app store operators.

Generally, once an app developed by a developer is registered in an app store, a user may access the app store through wired or wireless communications and select the app, which may be downloaded to a user terminal or to a personal computer (PC) to be transferred to a user terminal.

Most app stores operating online are app stores operated by terminal operating system developers (e.g., Apple's App Store, Google's Google Play, etc.), app stores operated by mobile carriers that provide mobile telecommunications services (e.g., SK telecom's T-Store, KT's Olleh Market, LG Uplus's U+ App Market, etc.), or app stores operated by some portal sites (e.g., Naver's N Store, Daum's TV App Store, etc.). Users generally access app stores operated by operating system developers of their own terminals, or access app stores operated by mobile carriers to which they have subscribed, so as to search for desired apps and download them to their terminals.

For example, as smart TV app stores are operated independently by each domestic developer, an app store of each developer only deals with apps for their own smart TV, such that their apps are not compatible with other smart TVs. Further, mobile app stores are also operated independently by each mobile carrier.

In other words, since several app stores are individually operated by each app store operator, users are required to access each app store using client webs provided by each app store for accessing app stores.

An HTML5 standard has been developed to meet the need for apps that are not dependent on hardware or on operating platforms, and in which web apps that support the HTML5 standard may run in the HTML5 browser. Accordingly, even in a case where operating software platforms and hardware devices of mobile terminals are different, apps may run as long as the HTML5 browser is mounted in mobile terminals.

In Korea, a domestic mobile software standard for a widget type has been defined, which conforms to Wholesale Application Community (WAC) 2.0, an international mobile software standard, and a Korea's Integrated App Store (“K-Apps”) that conforms to the domestic mobile software standard was launched on November 2011. Widget Runtime is provided for WAC 2.0 widget mobile apps so that widgets may run on runtime regardless of the types of terminal operating software platforms.

That is, the K-apps provide widgets for each app store of mobile carriers, and mobile carriers distribute these widgets through their app stores. Accordingly, by once registering apps in the K-apps, developers may distribute and sell their own apps to each app store of all mobile carriers. Further, while in the past developers used to develop each app according to terminals of mobile carriers, now only one widget app may run in all terminals as long as the Widget Runtime is installed therein.

As described above, the development of apps is encouraged with the help of the HTML5 web app and K-apps, but is not as active in practice with users still searching for apps in app stores of specific terminal operating system developers or mobile carriers. In addition, as there is actually no service that allows users to search for several app stores all together, users have to search for desired apps on the web first and then access app stores.

### SUMMARY

Provided is an apparatus and method for interworking between a plurality of app store servers to allow access to app information on apps registered with other different app store servers through one app store server.

In the present exemplary embodiments, app information on apps, which are registered with different app store servers, may be provided to other app store servers through an open service interface, i.e. an open application programming interface (API).

That is, by providing app store functions through the open API, a user may retrieve and access other app stores even when using a single app store client app, thereby providing a user with improved accessibility to app stores.

As app store servers interwork with each other based on a standard service interface to exchange and share app information therebetween, various terminals and platform environments may be supported, providing improved convenience and user accessibility.

Further, the present exemplary embodiments provide an open app store interworking model, in which even if the types of user terminals, the types of services, or business environments are different, services may be expanded efficiently, and a common user environment may be developed to enable conventional app stores operated separately by their respective operators to be accessed by a standardized method. As a result, the development of HTML5 web apps not dependent on platforms is expected to increase, along with the growth of app stores that distribute these apps.

In one general aspect, there is provided an apparatus for interworking between a plurality of servers to share app information, the apparatus including: a provider module configured to provide app information on a first app registered with an app store server to one or more other app store servers, or to enable the one or more other app store servers to acquire the app information; and a proxy module configured to be provided with or acquire app information on a second app registered with the one or more other app store servers.

The provider module may include an app information storage in which the app information on the first app is stored; an app information catalog storage configured to fetch the app information on the first app from the app information storage, to list the app information, and to store the listed app information as an app information catalog; and an app information catalog service interface configured to provide the app information catalog to the one or more other app store servers, or to enable the one or more other app store servers to acquire the app information catalog.

The provider module may further include: an app execution package file storage in which an app execution package file of the first app is stored; and an app execution package file download service interface configured to provide the app execution package file of the first app to the one or more other app store servers, or to enable the one or more other app store servers to acquire the app execution package file of the first app.

The proxy module may include: an app information catalog requestor configured to request an app information catalog stored in the app information catalog storage where the app information on the second app, which is intended to be provided to or to be acquired by the app store, is fetched from the app information storage, in which the app information on the second app registered with the one or more other app store servers is stored, to be listed and stored; and an app information catalog acquirer configured to receive or acquire the requested app information catalog from the one or more other app store servers.

The proxy module may further include: an app execution package file requestor configured to request the app execution package file of the second app from the one or more other app store servers; and an app execution package file acquirer configured to receive or acquire the app execution package file of the second app from the one or more other app store servers.

The app information may include one or more of the following: an identification (ID), a name, a category, an registrant, a registration date, an execution package name, a developer, a development year, required SDK version, an icon image, a file name, a change history, a downloading number, an APK file path, or an app execution package file.

In another general aspect, there is disclosed an intermediary server, which includes: an app information receiving service interface configured to receive, from a plurality of app store servers, app information on apps each registered with the plurality of app store servers; an app information catalog storage configured to list the app information received through the app information receiving service interface and to store the listed app information as an app information catalog; and an app information transmitting service interface configured to provide the app information catalog to the plurality of app store servers, or to enable the plurality of app store servers to acquire the app information catalog.

The app information catalog storage may include: an app list generator configured to generate a list of the app information received through the app information receiving service interface; and an app update list generator configured to generate a list of app information on updated apps among the app information received through the app information receiving service interface.

In yet another general aspect, there is disclosed a method for interworking between a plurality of app store servers to share app information on a first app registered with an app store server among one or more other app store servers, the method including: executing a retrieval application to retrieve app information on a second app registered with the one or more other app store servers; transmitting, to the one or more other app store servers, a first request message to request an app information catalog on the second app registered with the one or more other app store servers; receiving or acquiring, from the one or more other app store servers, the app information catalog of the second app requested in the first message; displaying the received or acquired app information catalog of the second app; and determining whether selection has been made to download an app execution package file of the second app from the app information catalog of the second app.

The method may further include: fetching the app information on the second app registered with the one or more other app store servers; generating an app information catalog by listing the fetched app information of the second app; and providing the generated app information catalog to the app store server or enabling the app store server to acquire the generated app information catalog.

The method may further include: transmitting, to the one or more other app store servers, a second request message to request an app execution package file of the second app registered with the one or more other app store servers; and providing the app execution package file of the second app requested in the second request message to the app store server from the one or more other app store servers, or enabling the app store server to acquire the requested app execution package file.

In still another general aspect, there is disclosed a method for interworking between a plurality of servers to share app information therebetween, the method including: receiving, from the plurality of servers, app information on each app registered with the plurality of servers; listing the received app information to generate an app information catalog; and providing the generated app information catalog to the plurality of app store servers, or enabling the plurality of app store servers to acquire the generated app information catalog.

The method may further include generating an app information catalog of all apps registered in the plurality of app store servers to provide the generated app information catalog of all apps.

The method may further include generating an app information catalog of regularly updated apps among apps registered with the plurality of app store servers to provide the generated app information catalog of regularly updated apps.

The method may further include: requesting an app information catalog of updated apps among apps registered in the plurality of app store servers; generating an app information catalog of updated apps in response to the request; and providing the generated app information catalog of updated apps.

The app information catalog of updated apps comprises one or more of a list of new apps, a list of updated apps, or a list of deleted apps.

### BRIEF DESCRIPTION OF THE DRAWINGS

FIG. 1 is a block diagram illustrating an example of interworking between a plurality of app store servers to share app information therebetween.

FIG. 2 is a block diagram illustrating an example of an apparatus for interworking between a plurality of app store servers to share app information therebetween according to an exemplary embodiment, in which the apparatus includes a provider module and a proxy module in an app store server.

FIG. 3 is a detailed diagram illustrating the provider module in the apparatus for interworking between app store servers provided in the app store servers of FIG. 2.

FIG. 4 is a detailed diagram illustrating the proxy module in the apparatus for interworking between app store servers provided in the app store servers of FIG. 2.

FIG. 5 is a diagram illustrating an example of sharing app information through interworking between a plurality of app stores according to an exemplary embodiment.

FIG. 6 is a diagram illustrating an example of interworking between a plurality of app stores via an intermediary server to share app information according to an exemplary embodiment.

FIG. 7 is a diagram illustrating an example of an app information catalogue storage in an intermediary server according to an exemplary embodiment.

FIG. 8 is a diagram illustrating an example of a method for interworking between a plurality of app store servers to share app information according to an exemplary embodiment.

FIG. 9 is a diagram illustrating an example of another method for interworking between a plurality of app store servers to share app information according to an exemplary embodiment.

FIGS. 10 and 11 are diagrams illustrating an example of a method for interworking between a plurality of app store servers via an intermediary server to share app information according to an exemplary embodiment.

FIG. 12 is a diagram illustrating an example of another method for interworking between a plurality of app store servers via an intermediary server to share app information according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

An app store server suggested herein provides a service of retrieving and downloading apps that are registered with the app store server, or apps that are not registered with the app store server but with other app store servers.

That is, when a user accesses a specific app store through wired or wireless communications, apps that are registered with an app store server accessed by a user may be retrieved to be downloaded to the user's terminal and installed therein, and apps registered with other app store servers may also be retrieved through the app store server accessed by the user to be downloaded to the user's terminal and installed therein.

In order to provide a service of retrieving and downloading apps that are not registered with their own app store server but with other app store servers, each app store server may include an apparatus for interworking between app store servers to provide app information, in which the apparatus includes a provider module and a proxy module.

The provider module is a module that transmits app information of apps registered with their own app store server to other app store servers. The proxy module is a module that requests app information on apps that are not registered with their own app store server but with other app store servers, from app store servers with which the apps are registered, and receives the requested app information, or receives an app execution package file.

Information on an application includes information such as an ID, a name, an explanation, a category, a registrant, a registration date, an execution package name, a developer, a development date, a version, required SDK version, an icon image, a file name, a change history, a downloading number, an Android Package (APK) file path, as well as an APK file that is an execution package file.

Further, the exemplary embodiments provide an apparatus and method for interworking between app store servers for providing app information, in which the process of interworking between a plurality of app store servers for exchanging app information on apps registered with each of the app store servers is performed by dividing app stores into provider app stores that provide app information and proxy app stores that fetch the provided information to users. Hereinafter, an app store server that functions as a provider app store will be referred to as a provider app store server, and an app store server that functions as a proxy app store will be referred to as a proxy app store server.

An apparatus and method for interworking between app store servers to provide app information will be described below with reference to the following drawings.

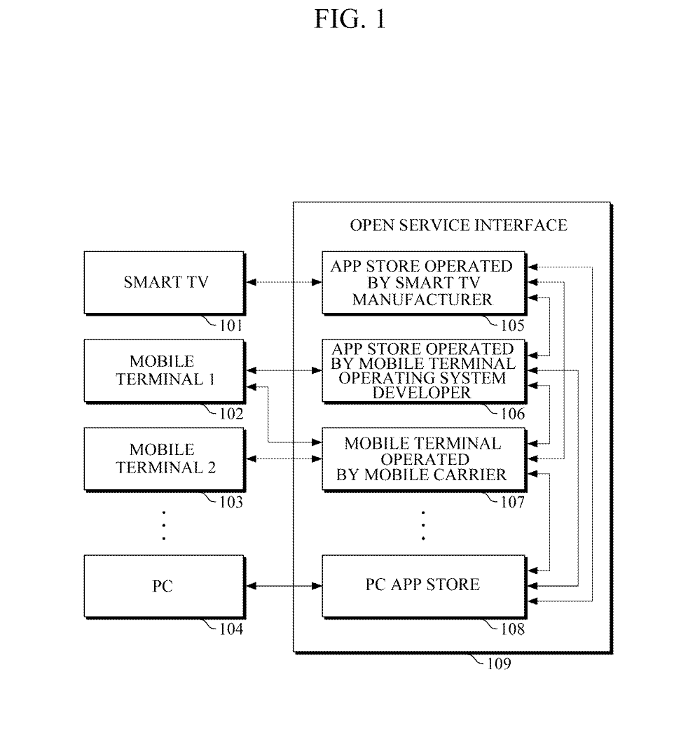

FIG. 1 is a block diagram illustrating an example of interworking between a plurality of app store servers to share app information therebetween.

The present disclosure provides one method for improving distribution of apps, in which a plurality of app store servers interwork with each other to enable users to retrieve and use as many apps as possible through one app store. As a result, as illustrated in FIG. 1, app information on apps registered with each app store server may be exchanged among a plurality of app store servers through an open service interface, i.e. application programming interface (API) in 109.

For example, a smart TV user may connect to an app store of the smart TV manufacturer to retrieve and download apps, and mobile terminal users may retrieve and download apps by connecting to an app store (e.g., Apple's App Store, Google's Google Play, etc.) operated by the terminal operating system developer or by connecting to an app store operated by a mobile carriers that provide mobile telecommunications services (e.g., SK telecom's T-Store, KT's Olleh Market, LG Uplus's U+App Market and the like).

However, when connecting to app stores of smart TV manufacturers, smart TV users may not retrieve and download apps that are registered with other app store servers, such as app stores operated by mobile terminal operating system developers or app stores operated by mobile carriers.

By contrast, in an exemplary embodiment of FIG. 1, app information on apps registered with each app store server may be exchanged among a plurality of app store servers through an open API, such that even when connected to app stores of smart TV manufacturers, smart TV users may retrieve and download apps registered with other app stores such as app stores operated by mobile terminal operating system developers or app stores operated by mobile carriers.

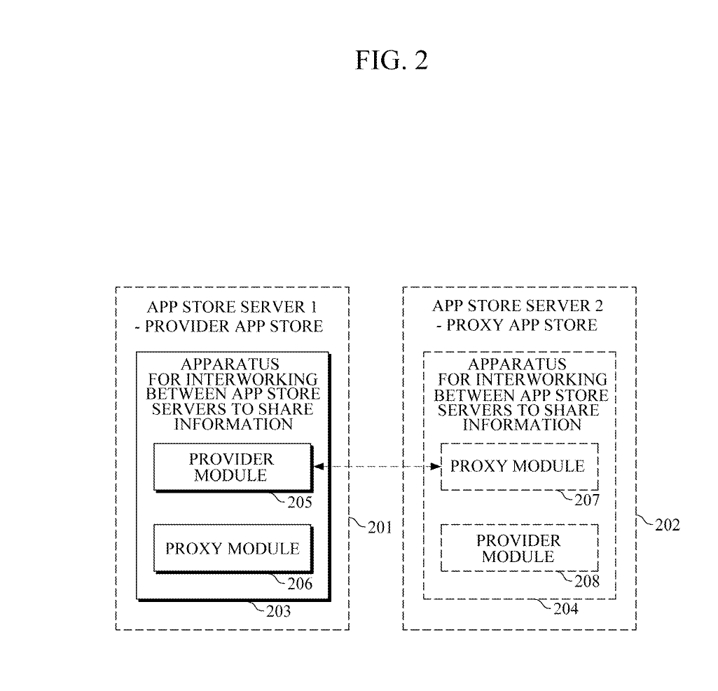

FIG. 2 is a block diagram illustrating an example of an apparatus for interworking between a plurality of app store servers to share app information therebetween according to an exemplary embodiment, in which the apparatus includes a provider module and a proxy module in an app store server.

Referring to FIG. 2, an apparatus 203 for interworking between a plurality of app store servers to share app information therebetween is provided in each of the app store servers, in which the apparatus 203 includes provider modules 205 and 208 and proxy modules 206 and 207.

The provider modules 205 and 208 are modules that provide app information on apps registered with their own app store to other app store servers, and the proxy modules 206 and 207 are modules that request app information on apps not registered with their own app store server from app store servers with which the apps are registered, and receives the requested app information.

An app store server 1 201 acts as a provider app store server that provides app information on apps registered with their own app store server to other app store servers, and an app store server 2 202 acts as a proxy app store server that requests app information on apps registered with the app store server 1 201. Hereinafter, the app store server 1 201 that acts as a provider app store will be referred to as a provider app store server, and the app store server 2 202 that acts as a proxy app store will be referred to as a proxy app store server.

The apparatus 203 for interworking between a plurality of app store servers provided in the provider app store server may provide or receive app information on apps registered with each of the app store servers to and from the apparatus 204 for interworking between a plurality of app store servers provided in the proxy app store server. More specifically, the provider module 205 in the apparatus 203 for interworking between a plurality of app store servers provided in an app store server may provide or receive app information to and from the proxy module 207 in the apparatus 204 for interworking between a plurality of app store servers provided in other app store server.

The proxy module 207 in the apparatus 204 for interworking between a plurality of servers provided in the proxy app store server 202 requests desired app information from the provider module 205 in the apparatus 203 for interworking between a plurality of servers provided in the provider app store server 201, and fetches the requested app information. In a case where the provider module 205 directly transmits app information to the proxy module 207, overload may occur in the provider app store server system, or transmission may fail, thereby requiring retransmission and the like. Accordingly, by allowing the proxy module 207, which intends to acquire app information, of the proxy app store server 202 to acquire app information, rather than transmitting app information by the provider module 205 of the provider app store server 201, system load may be distributed. That is, while the provider module 205 may directly provide app information to the proxy module 207, the provider module 205 may also allow the proxy module 207 to access and acquire app information.

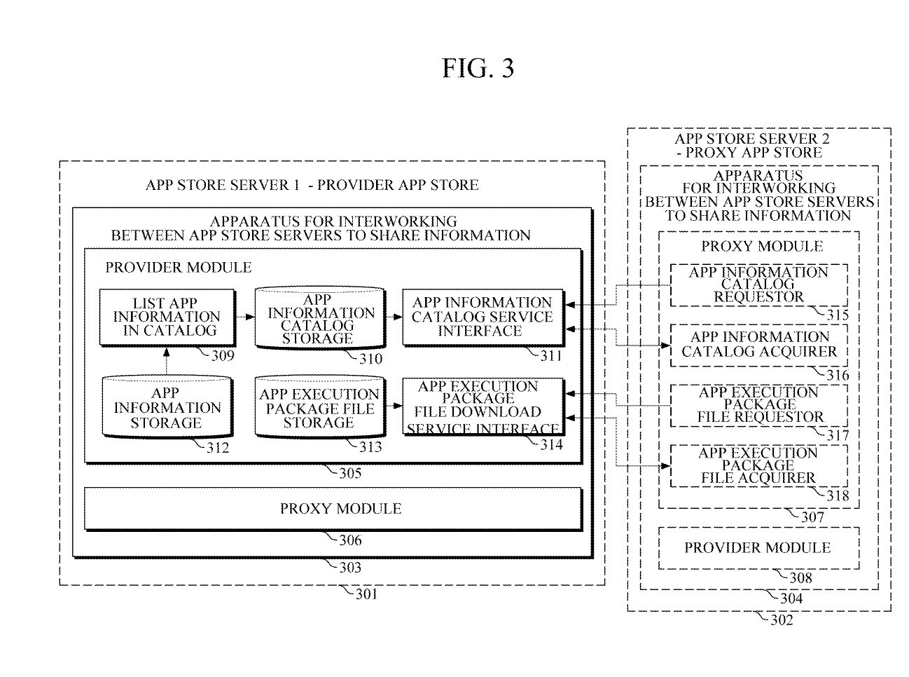

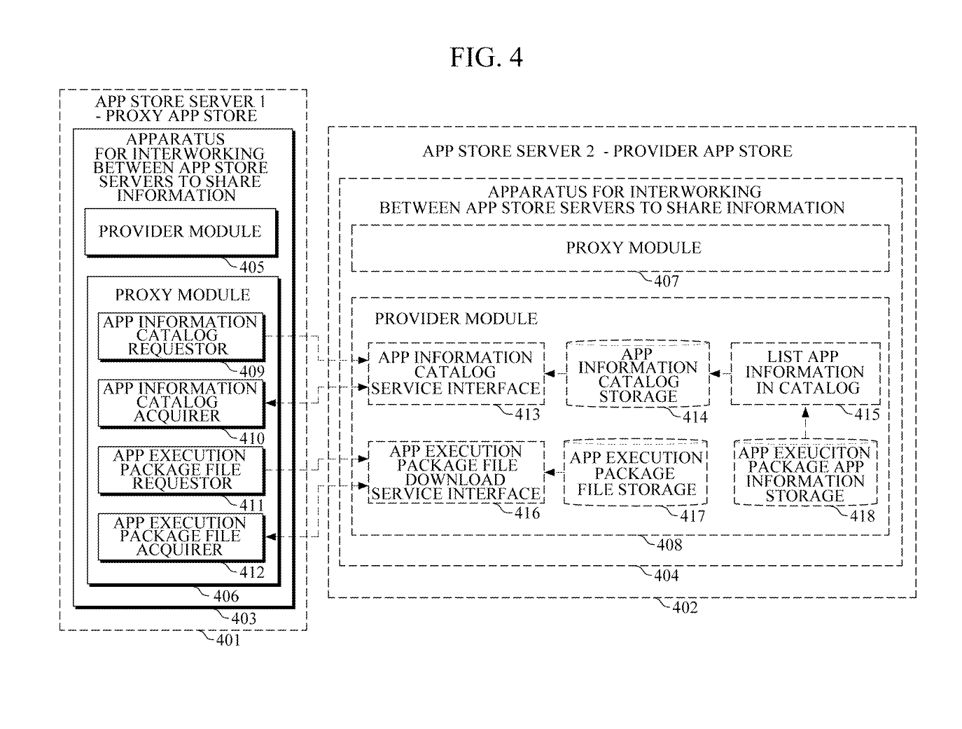

The provider module and the proxy module will be described in detail with reference to FIGS. 3 and 4.

FIG. 3 is a detailed diagram illustrating the provider module in the apparatus for interworking between app store servers provided in the app store servers in FIG. 2.

Referring to FIG. 3, the provider module 305 in the apparatus 303 for interworking between a plurality of app store servers provided in the provider app store server includes app information storage 312, app information catalog storage 310, app information catalog service interface 311, app execution package file storage 313, and app execution package file download service interface 314.

The app information storage 312 is where app information on apps registered with the provider app store server is stored. The app information catalog storage 310 is where app information is listed in a catalog to be stored, such that the app information stored in the app information storage may be provided to other app store servers, or other app store servers may acquire the app information. The app information catalog service interface 311 provides the app information catalog stored in the app information catalog storage to other app store servers, or allows the other app store servers to acquire the app information catalog.

The app execution package file storage 311 is where an app execution package file of apps registered with the provider app store server is stored. The app execution package file download service interface 314 provides the app execution package file to other app store servers, or allows other app store servers to acquire the app execution package file.

The provider module 305 in the apparatus 303 for interworking between a plurality of app store servers provided in the provider app store server 301 provides the app information catalog service interface 311 and the app execution package file download service interface 3314, thereby enabling the proxy module 307 to request and acquire app information in the same manner as above. The provider module 305 fetches app information to be provided from the app information storage 312, lists the app information in a catalog, and stores the app catalog in the app information catalog storage 310. Since the app catalog may be accessed through the app information service interface 311, the provider module 305 enables the proxy module 307 to fetch desired app information. By using an APK file path and download file server information provided in advance, the app execution software package (APK) file of the apps may be accessed separately through the app execution package file download service interface 314. That is, the proxy module 307 fetches app information catalog, which is a list of app information, from the provider module 305 through the app information catalog service interface 311, and displays the app information catalog to its own app store users. When a user requests to purchase a specific app and pays for the app, an app execution package (APK) file for the app is downloaded to the user through the app execution package file download service interface 314.

FIG. 4 is a detailed diagram illustrating the proxy module in the apparatus for interworking between app store servers provided in the app store servers of FIG. 2.

Referring to FIG. 4, the proxy module 406 in the apparatus 403 for interworking between a plurality of app store servers provided in the proxy app store server includes an app information catalog requestor 409, an app information catalog acquirer 410, app execution package file requestor 411, and an app execution package file acquirer 412.

The app information catalog requestor 409 requests app information on apps registered with other app store servers. The app information catalog acquirer 410 receives or acquires the app information catalog from other app store servers.

The app execution package file requestor 411 requests an app execution package file of apps registered with other app store servers. The app execution package file acquirer 412 receives or acquires an app execution package file of apps registered with the other app store servers.

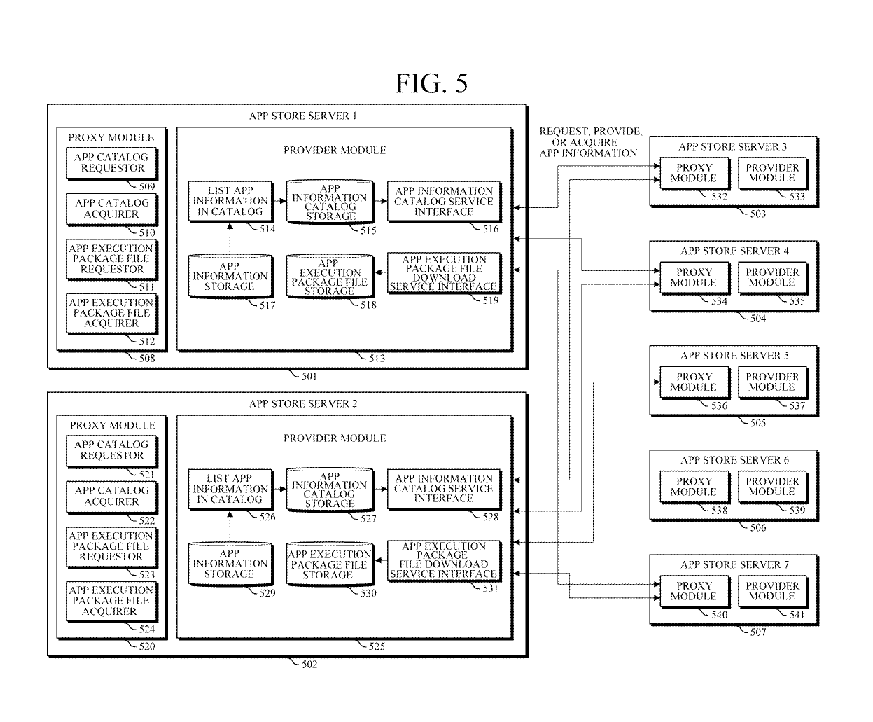

FIG. 5 is a diagram illustrating an example of sharing app information through interworking between a plurality of app stores according to an exemplary embodiment.

Referring to FIG. 5, an app store server 1 501 and an app store server 2 502 act as provider app stores, and an app store server 3 503, an app store server 4 504, an app store server 5505, an app store server 6 506, and an app store server 7 507 act as proxy app stores. Each of the app store server 1 501 and the app store server 2 502, which act as provider app stores, is required to have an identical service interface 516 and 528 so as to provide app information on apps registered with each of the app stores, and is required to have an execution module for service interface processing so that proxy modules 532, 534, 536, 538, and 540 of the app store servers 503, 504, 505, 506, and 507, each of which acts as a proxy app store, may interwork through the service interface 516 and 528.

In other words, by identically applying the standardized service interface 516 and 528 to access the app store server 1 501 and the app store server 2 502, the app store server 3 503, the app store server 4, 504, the app store server 5 505, the app store server 6 506, and the app store server 7 507, which are intended to acquire app information on apps registered with the app store server 1 501 or the app store server 2 502, may receive app information in the same manner, even though the app store server 1 501 and the app store server 2 502, which provide app information, process app information by different methods.

However, there is a problem in that each of all app store servers is required to separately install a service interface.

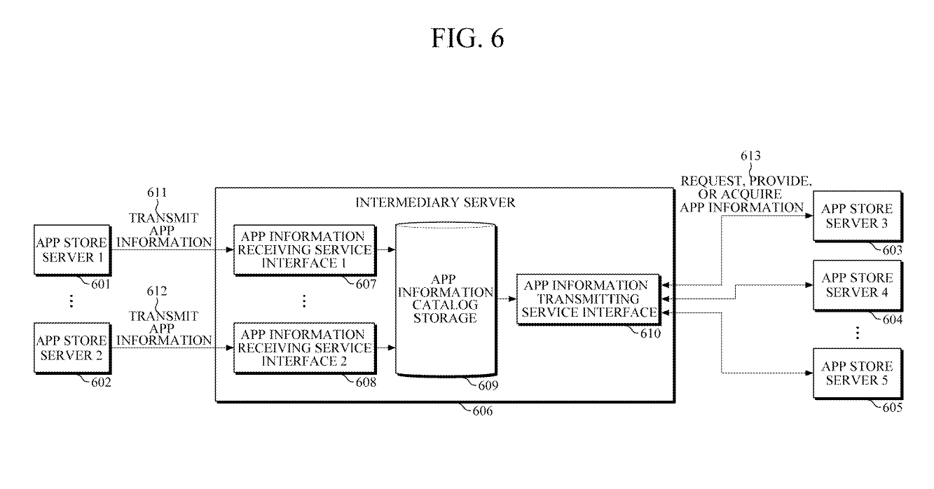

In order to solve this problem, the app information catalog storage 515 and 527 and the app information catalog service interface 516 and 528 may be separated in the provider module 513 and 525 in the apparatus for interworking between a plurality of app store servers provided in the app store server, and may be configured as an intermediary component, which will be described in detail with reference to FIG. 6 below.

FIG. 6 is a diagram illustrating an example of interworking between a plurality of app stores via an intermediary server to share app information according to an exemplary embodiment.

Referring to FIG. 6, the intermediary server 606 includes a plurality of app information receiving service interface 607 and 608, an app information catalog storage 609, and an app information transmitting service interface 610.

The plurality of app information receiving service interface 607 and 608 receive, from the plurality of app store servers 601 and 602, app information on apps registered with each of the plurality of app store serves. The app information catalog storage 609 is where app information received through the app information receiving service interface is listed and stored as an app information catalog. The app information transmitting service interface 610 transmits the app information catalog stored in the app information catalog storage to the plurality of app store servers 603, 604, and 605, or enables the plurality of app store servers to acquire the app information catalog.

For example, an app store server 1 601 and an app store server 2 602 act as provider app stores, and an app store server 3 603, an app store server 4 604, and an app store server 5 605 respectively act as proxy app stores.

Through the standardized, identical app information transmitting service interface 610 of the intermediary server 606, the app store server 3 603, the app store server 4, and the app store server 5 605, which act as proxy app stores, may request and acquire app information from the intermediary server 606 instead of from the app store server 1 601 or the app store server 2 602 that act as provider app stores. To this end, the intermediary server 606 is required to have a service interface execution module for sharing app information through interworking between app store servers, and the app store server 1 601 and the app store server 2 602 that act as provider app stores no longer need such module.

Further, the app store server 1 601 or the app store server 2 602 may transmit app information on apps registered with each of the app store servers to the intermediary server 606 by convenient transmission methods 611 and 612. To this end, the intermediary server 606 includes an app information receiving service interface 1 607 and an app information receiving service interface 2 608 that are suitable for the app store server 1 601 or the app store server 2 602, and the app information receiving service interface 1 607 and the app information receiving service interface 2 608 should be enabled to be used by the app store server 1 601 or the app store server 2 602, respectively.

As described above, by having the intermediary server 606, app store servers that act as provider app stores may use a suitable transmission method to transmit app information to the intermediary server 606 when providing an app information catalog service interface, without any need for adjusting an interface in their own system, thereby enabling easy interworking between app store servers.

Further, the intermediary server 606 may have an additional function for providing a notification service when there is a problem with an app store server that acts as a provider app store, so as to provide an additional function for an app store server that acts as a proxy app store, and app information to be exchanged is managed by the intermediary server 606, such that security and reliability may be secured in management.

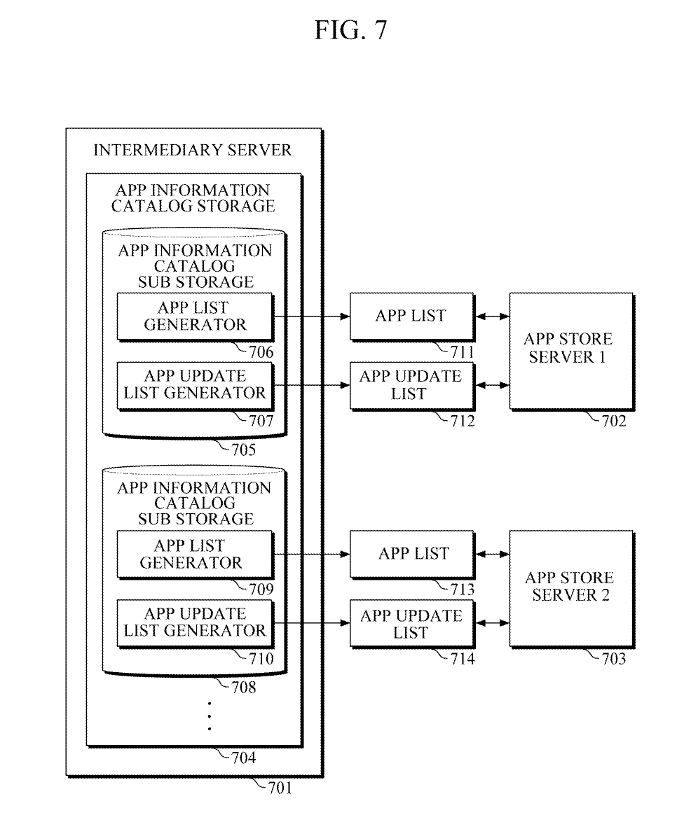

FIG. 7 is a diagram illustrating an example of an app information catalogue storage in an intermediary server according to an exemplary embodiment.

Referring to FIG. 7, the app information catalog storage 704 includes a plurality of sub storages of an app information catalog, in which each of the sub storages includes an app list generator and an app update list generator.

The app list generator lists app information received through the app information receiving service interface, and the app update list generator lists app information about updated apps among app information received through the app information receiving service interface.

For example, the intermediary server 701 includes an app information catalog sub storage 1 705 or an app information catalog sub storage 2 708 in the app information catalog storage 704 for an app store server 1 702 or an app store server 2 703 that act as proxy app stores, and each of the app information catalog sub storages stores app information to transmit the information to the app store server 1 702 or the app store server 2 703, respectively. That is, the app information catalog sub storage 1 705 is a storage assigned for the app store server 1 702, and the app information catalog sub storage 2 708 is a storage assigned for the app store server 2 703.

Information stored in the app information catalog storage is information about apps that have been permitted under contract with app stores that act as provider app stores. Each of the app information catalog sub storages 705 and 708 stores app information regularly transmitted from app store servers that act as provider app stores, and app stores servers that act as proxy app stores fetches initial lists 711 and 713 of all app information, and then regularly fetches summary lists 712 and 714 of updated app information. Further, the app stores servers that act as proxy app stores may also request and acquire lists of new apps, updated apps, and deleted apps. In addition, all information of apps registered with app store servers that act as provider app stores may be collected from an app information catalog sub storage to be provided to an app store server that acts as a specific proxy app store, in which the intermediary server 701 may proxy for app store servers that act as provider app stores to determine app store servers that acts proxy app stores and apps to be provided thereto.

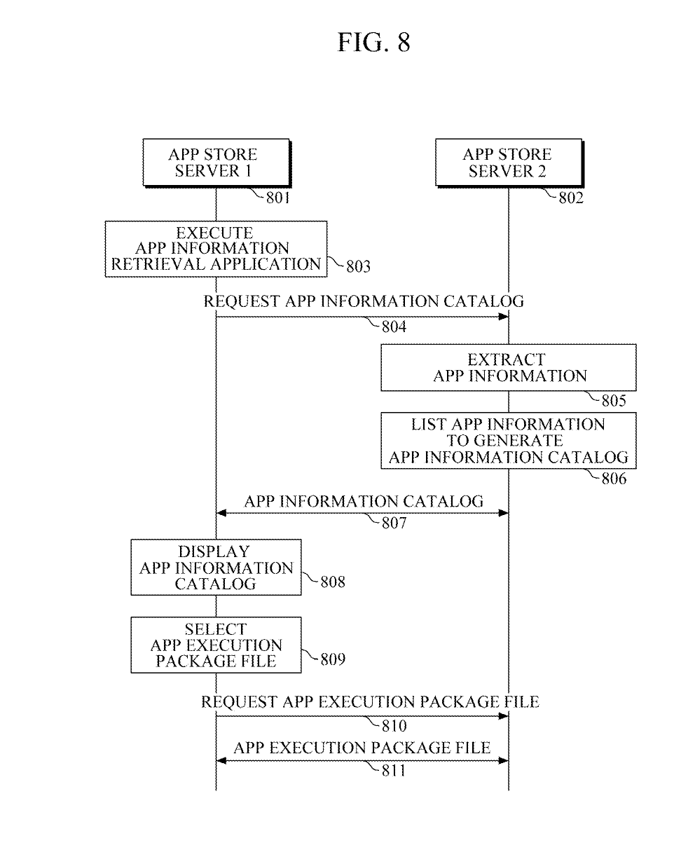

FIG. 8 is a diagram illustrating an example of a method for interworking between a plurality of app store servers to share app information according to an exemplary embodiment.

Referring to FIG. 8, app store servers may receive, from one or more other app store servers, app information on apps registered with the one or more other app store servers. For example, the app store server 801 requests from other app store server 802 app information on apps registered with the other app store server 802. In response to the request of the app store server 801, the other app store server 802 provides app information on apps registered with the other app store server 802 to the app store server 801, or enables the app store server 801 to acquire the app information.

First, the app store server 801 receives input of an execution event to execute a retrieval application to retrieve app information on apps registered with the other app store server 802. Upon detecting the execution event, the app store server 801 generates a first request message to request an app information catalog and transmits the generated message to the other app store server 802 in 804.

Next, when the other app store server 802 receives the first request message from the app store server 801, the other app store server extracts app information on apps registered with the other app store server in 805, and lists the extracted app information to generate an app information catalog in 806.

Then, the generated app information catalog may be provided to the app store server 801 or the app store server 801 may acquire the generated app information catalog.

Subsequently, upon receiving the generated app information catalog, the app store server 801 displays the app information catalog and receives input of a selection event to select an app execution package file.

Upon detecting the selection event, the app store server 801 generates a second request message to request the app execution package file and transmits the generated message to the other app store server 802 in 810.

The other app store server 802 may provide the app execution package file requested in the second request message to the app store server 801, or may enable the app store server 801 to acquire the requested app execution package file.

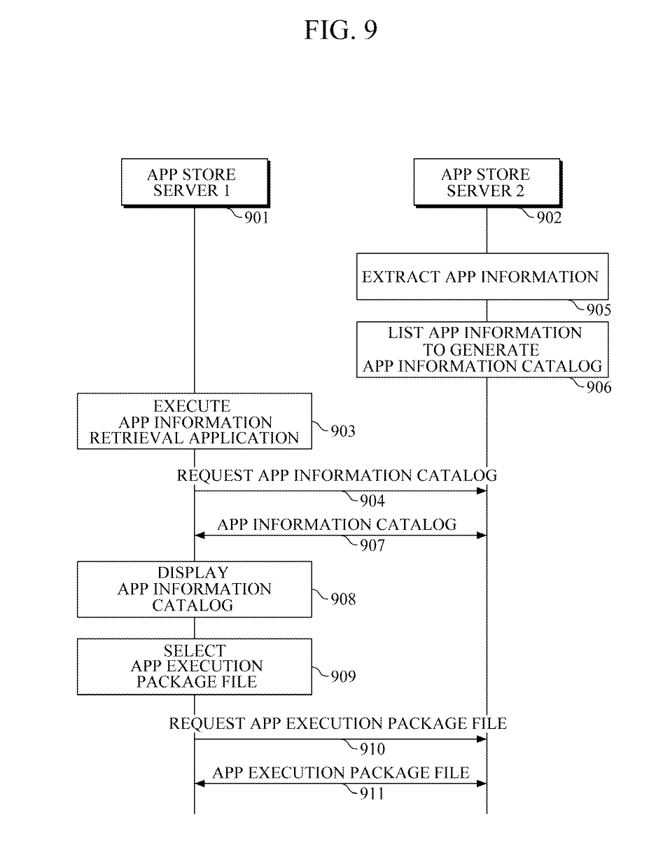

FIG. 9 is a diagram illustrating an example of another method for interworking between a plurality of app store servers to share app information according to an exemplary embodiment.

Referring to FIG. 9, app information on apps registered with other app store server 902 is extracted in 905 and listed to be generated as an app information catalog in 906.

Next, an app store server 901 receives input of an execution event to execute retrieval application to retrieve app information on apps registered with the other app store server 902. Upon detecting the execution event, the app store server generates a first request message to request app information catalog and transmits the generated message to the other app store server 902.

Then, upon receiving the first request message from the app store server 901, the other app store server 902 provides the generated app information catalog to the app store server 901 or may enable the app store server 901 to acquire the generated app information catalog.

Subsequently, upon receiving the generated app information catalog, the app store server 901 displays the app information catalog, and receives input of a selection event to select an app execution package file.

Upon detecting the selection event, the app store server 901 generates a second request message to request the app execution package file and transmits the generated message to the other app store server 902 in 810.

Then, the other app store server 902 may provide the app execution package file requested in the second request message to the app store server 901, or may enable the app store server 901 to acquire the requested app execution package file.

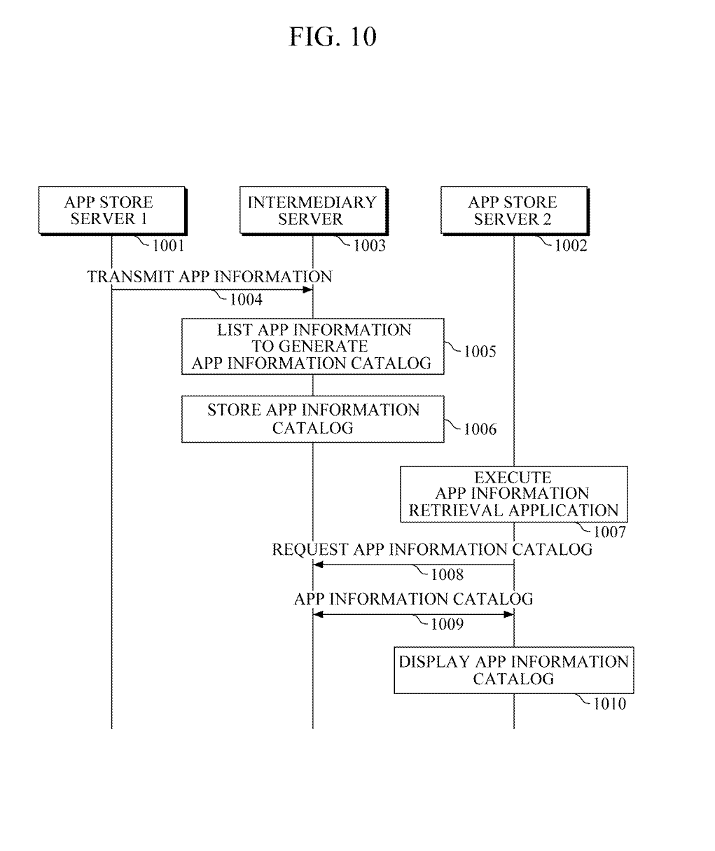

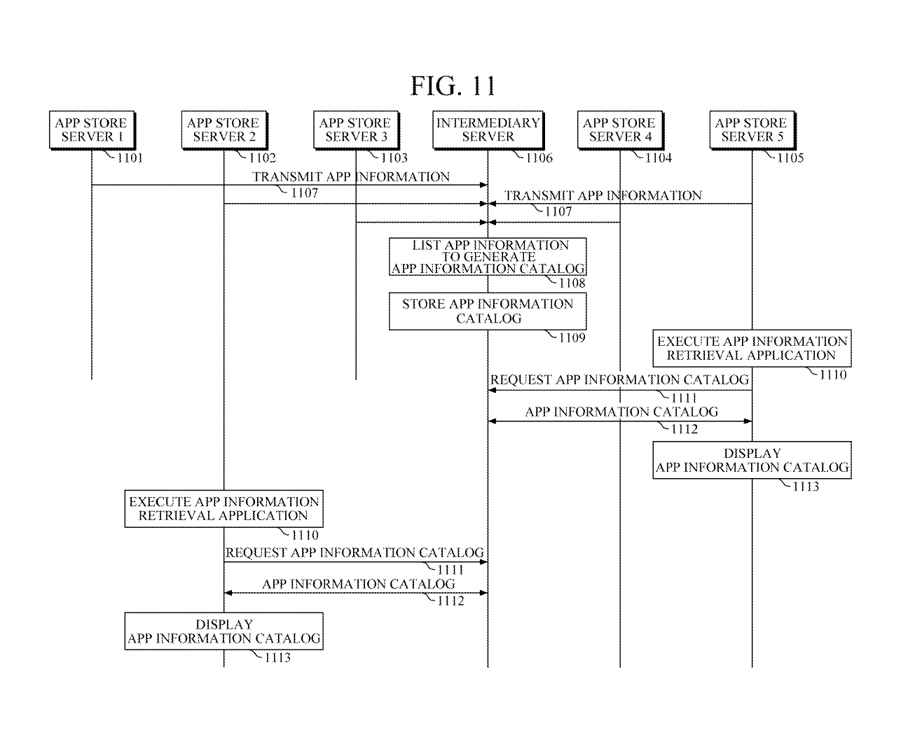

FIGS. 10 and 11 are diagrams illustrating an example of a method for interworking between a plurality of app store servers via an intermediary server to share app information according to an exemplary embodiment.

Referring to FIGS. 10 and 11, an app store server 1001 transmits app information on apps registered therewith to an intermediary server 1003 in 1004.

Next, the intermediary server 1003 lists the app information transmitted from the app store server 1001 in an app information catalog, and store the catalog in 1006.

Other app store server 1002 receives input of an execution event to execute a retrieval application to retrieve app information on apps registered with the app store server 1001. Upon detecting the execution event, the other app store server 1002 generates a first request message to request an app information catalog, and transmits the generated message to the intermediary server 1003 in 1008.

Then, upon receiving the first request message from the other app store server 1002, the intermediary server 1003 may provide the generated app information catalog to the other app store server 1002, or may enable the other app store server 1002 to acquire the generated app information catalog.

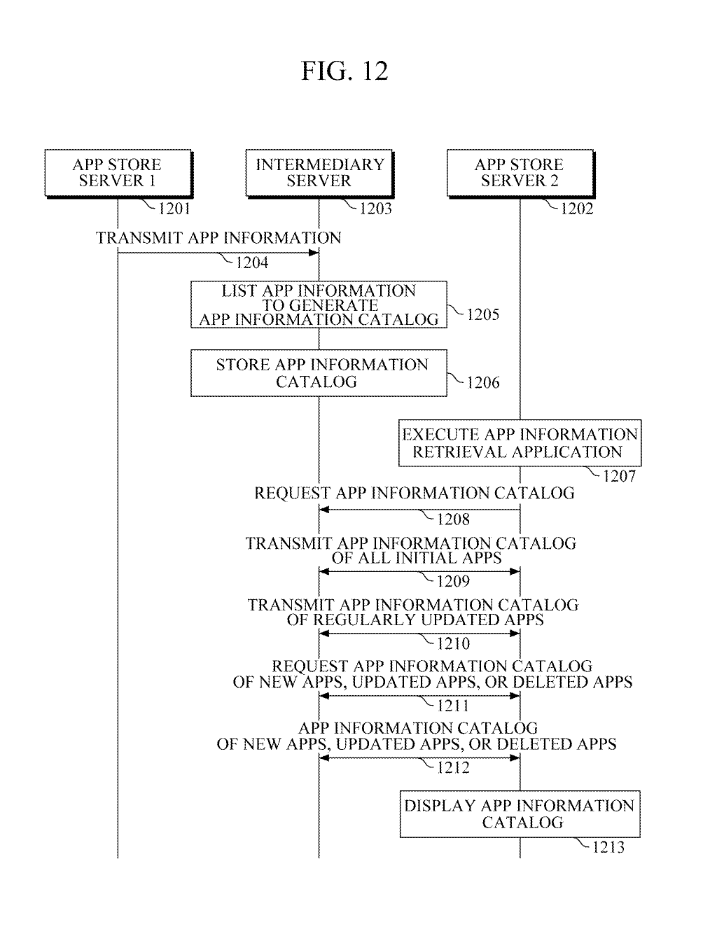

FIG. 12 is a diagram illustrating an example of another method for interworking between a plurality of app store servers via an intermediary server to share app information according to an exemplary embodiment.

Referring to FIG. 12, an app store server 1201 transmits app information on apps registered therewith to an intermediary server 1203 in 1204.

Next, the intermediary server 1203 lists the app information transmitted from the app store server 1201 in an app information catalog, and stores the catalog in 1206.

Other app store server 1202 receives input of an execution event to execute a retrieval application to retrieve app information on apps registered with the app store server 1201. Upon detecting the execution event, the other app store server 1202 generates a first request message to request an app information catalog and transmits the generated message to the intermediary server 1203 in 1208.

Then, upon receiving the first request message from the other app store server 1202, the intermediary server 1203 may provide the generated app information catalog of all the initially registered apps to the other app store server 1202, or may enable the other app store server 1202 to acquire the generated app information catalog.

Further, the intermediary server 1203 may provide the other app store server 1202 with an updated app information catalog among app information provided regularly from the app store server 1201, or may enable the other app store server 1202 to acquire the updated app information catalog.

Upon receiving a second request message that requests an app information catalog of new apps, updated apps, or deleted apps from the other app store server 1202, the intermediary server 1203 may provide the other app store server 1202 with an app information catalog of new apps, updated apps, or deleted apps among app information transmitted from the app store server 1201, or may enable the other app store server 1202 to acquire the catalog.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for interworking between a plurality of servers to share app information therebetween, the apparatus comprising:
a provider module configured to provide app information on a first app registered with an app store server to one or more other app store servers, or to enable the one or more other app store servers to acquire the app information; and
a proxy module configured to be provided with or acquire app information on a second app registered with the one or more other app store servers.

2. The apparatus of claim 1, wherein the provider module comprises:
an app information storage in which the app information on the first app is stored;
an app information catalog storage configured to fetch the app information on the first app from the app information storage, to list the app information, and to store the listed app information as an app information catalog; and
an app information catalog service interface configured to provide the app information catalog to the one or more other app store servers, or to enable the one or more other app store servers to acquire the app information catalog.

3. The apparatus of claim 2, wherein the provider module further comprises:
an app execution package file storage in which an app execution package file of the first app is stored; and
an app execution package file download service interface configured to provide the app execution package file of the first app to the one or more other app store servers, or to enable the one or more other app store servers to acquire the app execution package file of the first app.

4. The apparatus of claim 1, wherein the proxy module comprises:
an app information catalog requestor configured to request an app information catalog stored in the app information catalog storage where the app information on the second app, which is intended to be provided to or to be acquired by the app store, is fetched from the app information storage, in which the app information on the second app registered with the one or more other app store servers is stored, to be listed and stored; and
an app information catalog acquirer configured to receive or acquire the requested app information catalog from the one or more other app store servers.

5. The apparatus of claim 4, wherein the proxy module further comprises:
an app execution package file requestor configured to request the app execution package file of the second app from the one or more other app store servers; and
an app execution package file acquirer configured to receive or acquire the app execution package file of the second app from the one or more other app store servers.

6. The apparatus of claim 1, wherein the app information comprises one or more of the following: an identification (ID), a name, a category, an registrant, a registration date, an execution package name, a developer, a development year, required SDK version, an icon image, a file name, a change history, a downloading number, an APK file path, or an app execution package file.

7. An intermediary server, comprising:
an app information receiving service interface configured to receive, from a plurality of app store servers, app information on apps each registered with the plurality of app store servers;
an app information catalog storage configured to list the app information received through the app information receiving service interface and to store the listed app information as an app information catalog; and
an app information transmitting service interface configured to provide the app information catalog to the plurality of app store servers, or to enable the plurality of app store servers to acquire the app information catalog.

8. The intermediary server of claim 7, wherein the app information catalog storage comprises:
an app list generator configured to generate a list of the app information received through the app information receiving service interface; and
an app update list generator configured to generate a list of app information on updated apps among the app information received through the app information receiving service interface.

9. A method for interworking between a plurality of app store servers to share app information on a first app registered with an app store server among one or more other app store servers, the method comprising:
executing a retrieval application to retrieve app information on a second app registered with the one or more other app store servers;
transmitting, to the one or more other app store servers, a first request message to request an app information catalog on the second app registered with the one or more other app store servers;
receiving or acquiring, from the one or more other app store servers, the app information catalog of the second app requested in the first message;
displaying the received or acquired app information catalog of the second app; and
determining whether selection has been made to download an app execution package file of the second app from the app information catalog of the second app.

10. The method of claim 9, further comprising:
fetching the app information on the second app registered with the one or more other app store servers;
generating an app information catalog by listing the fetched app information of the second app; and
providing the generated app information catalog to the app store server or enabling the app store server to acquire the generated app information catalog.

11. The method of claim 10, further comprising:
transmitting, to the one or more other app store servers, a second request message to request an app execution package file of the second app registered with the one or more other app store servers; and
providing the app execution package file of the second app requested in the second request message to the app store server from the one or more other app store servers, or enabling the app store server to acquire the requested app execution package file.

12. A method for interworking between a plurality of servers to share app information therebetween, the method comprising:
receiving, from the plurality of servers, app information on each app registered with the plurality of servers;
listing the received app information to generate an app information catalog; and
providing the generated app information catalog to the plurality of app store servers, or enabling the plurality of app store servers to acquire the generated app information catalog.

13. The method of claim 12, further comprising generating an app information catalog of all apps registered in the plurality of app store servers to provide the generated app information catalog of all apps.

14. The method of claim 13, further comprising generating an app information catalog of regularly updated apps among apps registered with the plurality of app store servers to provide the generated app information catalog of regularly updated apps.

15. The method of claim 14, further comprising:
requesting an app information catalog of updated apps among apps registered in the plurality of app store servers;
generating an app information catalog of updated apps in response to the request; and
providing the generated app information catalog of updated apps.

16. The method of claim 14, wherein the app information catalog of updated apps comprises one or more of a list of new apps, a list of updated apps, or a list of deleted apps.
